(19) United States
(12) Patent Application Publication
(10) Pub. No.: US 2026/0077946 A1
(43) Pub. Date: Mar. 19, 2026

(54) STORAGE AND RETRIEVAL SYSTEM

(71) Applicant: Ocado Innovation Limited, Hatfield (GB)

(72) Inventors: Richard POLLARD, Hatfield (GB); Ben PETTITT, Hatfield (GB); Kevin FAUX, Hatfield (GB)

(21) Appl. No.: 19/332,636

(22) Filed: Sep. 18, 2025

Related U.S. Application Data
(63) Continuation of application No. PCT/EP2024/057861, filed on Mar. 22, 2024.

(30) Foreign Application Priority Data
Mar. 22, 2023 (GB) 2304191.6

(51) Int. Cl. B65G 1/04; B65G 43/00

(52) U.S. Cl. CPC B65G 1/0478; B65G 1/0464; B65G 43/00; B65G 2203/045

(57) ABSTRACT

A storage and retrieval system comprising: a grid framework structure including a plurality of storage columns for storing stacks of storage containers, and a track system arranged in a grid pattern above the storage columns for guiding one or more robotic load handling devices, each storage column being below a single grid cell; a plurality of stacks of storage containers, each container having a bottom wall and upwardly standing sidewalls and end walls, each stack occupying a single storage column, the stacks including a plurality of first type storage containers having a metallic container body and a plurality of second type storage containers having a wireless transmittable container body; and an environmental monitoring system including at least one environmental sensor with a wireless communication device stored in a second type container to define a sensor container, and a base unit external of the grid framework for receiving environmental data.

### TECHNICAL FIELD

The present invention relates to the field of storage systems comprising robotic load handling devices operative on tracks located on a grid framework structure for handling storage containers stacked in the grid framework structure, and storage containers for use in such storage systems.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIG. 1 and FIG. 2, the storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 11. Each grid in the grid framework structure has at least one storage column 11 for storage of a stack of containers. FIG. 1 is a schematic perspective view of the grid framework structure 14, and FIG. 2 is a top-down view showing a single stack 12 of containers 10 arranged within the framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

The grid framework structure 14 comprises a plurality of upright members or upright columns 16 that support horizontal members 18, 20. A first set of parallel horizontal grid members 18 is arranged perpendicularly to a second set of parallel horizontal grid members 20 to form a grid structure lying in a substantially horizontal plane and supported by the upright members 16. The members 16, 18, 20 are typically manufactured from metal and typically welded or bolted together or a combination of both. The storage containers 10 are stacked between the upright members 16 of the grid framework structure 14, so that the grid framework structure 14 guards against horizontal movement of the stacks 12 of the storage containers 10, and guides vertical movement of the storage containers 10.

The top level of the grid framework structure 14 includes a track system 15 comprising a plurality of rails or tracks 22 arranged in a grid pattern across the top of the stacks 12. Referring additionally to FIG. 3, the rails 22 support a plurality of load handling devices or robotic load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. The track system 15 can be integrated into the grid structure in the sense that the first and second sets of tracks are respectively integrated into the first and second set of grid members. Alternatively, the track system 15 can be separate to the grid structure in the sense that the first and second sets of tracks are respectively mounted to the first and second sets of grid members. Each load handling device 30 comprises a vehicle body 32 which is arranged to travel in the X and Y directions on the tracks or rails 22 of the grid frame structure 14, above the stacks 12 (see FIG. 4). FIG. 4 and FIG. 5 show a load handling device 30 described in PCT Patent Publication No. WO2015/019055 (Ocado Innovation Limited) and International patent application WO 2015/140216 (Ocado Innovation Limited) comprising a vehicle body 32 equipped with a lifting mechanism 33 comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIG. 1 and FIG. 2. Typically, the grabber device 39 is configured as a lifting frame.

To grab a container 10, the grabber device 39 comprises four locating pins or guide pins nearby or at each corner of the grabber device 39 which mate with corresponding cut outs or holes formed at four corners of the storage container 10 and four gripper elements arranged at the bottom side of the grabber device 39 to engage with the rim of the storage container 10. The locating pins help to properly align the gripper elements with corresponding holes in the rim of the container. Each of the gripper elements comprises a pair of wings or legs that are collapsible to be receivable in corresponding holes in the rim of the storage container and an open enlarged configuration having a size greater than the holes in the rim of the storage container 10 in at least one dimension so as to lock onto the storage container 10. The wings are driven into the open configuration by a drive gear (not shown). More specifically, the head of at least one of the wings comprises a plurality of teeth that mesh with the drive gear such that when the gripper elements are actuated, rotation of the drive gear causes the pair of wings to rotate from a collapsed configuration to an open enlarged configuration.

The vehicle body 32 comprises an upper part and a lower part (see FIG. 5 (a and b)). The upper part of the vehicle body 32 may house a majority of the bulky components of the load handling device. Typically, the upper part of the vehicle body houses a driving mechanism for driving the wheels and the lifting mechanism together with an on-board rechargeable power source for providing the power to the driving mechanism and the lifting mechanism.

The lower part of the vehicle body 32 comprises a wheel assembly that is driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism comprising a winch, as shown in FIG. 5A and FIG. 5B. When in the recess, the container is lifted clear of the rails beneath, so that the load handling device can move laterally to a different location. Whilst the container receiving space 40 is shown in FIG. 5A and FIG. 5B arranged within the vehicle body 32, the container receiving space can be located below a cantilever as described in WO2019/238702 (Autostore Technology AS).

A typical storage and retrieval system 1 is shown in FIG. 3, the system having a plurality of load handling devices 30 active on the grid above the stacks 12. FIG. 1 and FIG. 3 show the bins or storage containers 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

Upon receipt of a customer order, a robotic load handling device operative to move on the tracks is instructed to pick up a storage bin containing the item of the order from a stack in the grid framework structure and transport the storage bin to a pick station whereupon the item can be retrieved from the storage bin. Typically, the load handling device transports the storage bin or container to a bin lift device that is integrated into the grid framework structure. A mechanism of the bin lift device lowers the storage bin or container to a pick station. Alternatively, the storage bin is lowered by the lifting mechanism of the robotic load handling device to the pick station.

A grid framework structure normally has at least one grid cell or storage column which is used not for storing storage containers, but which comprises a location where the load handling devices can drop off and/or pick up storage containers so that they can be transported to a second location (not shown in the prior art figures) where the storage containers can be accessed from outside of the grid framework structure or transferred out of or into the grid framework structure. Within the art, such a location is normally referred to as a “port” and the grid cell or storage column in which the port is located may be referred to as a “delivery column”. The storage columns typically comprise two delivery columns. A first delivery column may, for example, comprise a dedicated drop-off port where the robotic load handling vehicles or load handling vehicles can drop off storage containers to be transported through the delivery column and further to the pick station, and a second delivery column may comprise a dedicated pick-up port where the robotic load handling vehicles can pick up storage containers that have been transported through the second delivery column from the pick station, i.e. storage containers are fed into the pick station via the first delivery column and exit the access station via the second delivery column.

At the pick station, the item is retrieved from the storage bin. Picking can done manually by hand or by a robot. After retrieval from the storage bin, the storage bin is transported to a second bin lift device whereupon it is lifted to grid level to be retrieved by a load handling device and transported back into its location within the grid framework structure. Alternatively, the storage bin can be picked up by the lifting mechanism of the robotic load handling device through the pick-up port. A control system and a communication system keeps track of the location of the storage bins and their contents within the grid framework structure.

As individual storage containers are stacked in vertical layers in storage columns, their locations in the grid framework structure or “hive” may be indicated using co-ordinates in three dimensions to represent the load handling device or a container's position and a container depth (e.g. container at (X, Y, Z), depth W). Equally, locations in the grid framework structure may be indicated in two dimensions to represent the load handling device or a container's position and a container depth (e.g. container depth (e.g. container at (X, Y), depth Z). For example, Z=1 identifies the uppermost layer of the grid, i.e. the layer immediately below the rail system, Z=2 is the second layer below the rail system and so on to the lowermost, bottom layer of the grid. WO2015/185628A describes a storage and fulfilment system in which stacks of storage containers are arranged within a grid framework structure. The containers are accessed by load handling devices operative on tracks located on the top of the grid framework structure.

The system described with reference to FIGS. 1 to 3 has many advantages and is suitable for a wide range of storage and retrieval operations. In particular, it allows very dense storage of product, and it provides a very economical way of storing a huge range of different items in the bins 10, while allowing reasonably economical access to all of the bins 10 when required for picking.

As electronic commerce (e-commerce) continues to grow and overtake conventional brick and mortar retail practices, many businesses are facing challenges of maintaining or gaining relevance in an online marketplace and being able to compete with prominent players in the space. A typical supply chain involve the storage and retrieval of a large number of different products. For example, e-commerce and retail platforms that sell multiple product lines require systems that are able to store hundreds of thousands of different product lines having different temperature requirements. Different product items need to be maintained at different prescribed temperatures within a storage system, while the product items are stored and/or transported, and/or while orders are fulfilled. Some product items need to be maintained in a chilled or frozen environment to ensure freshness, while other product items can be stored or transported at ambient temperature. For example, where an order of one or more items involves the delivery of food and grocery goods that are of a perishable nature, storage of goods must adhere to strict temperature and environmental requirements, e.g. chilled or frozen temperature. For example, some types of food require a cool temperature environment (typically temperatures between 1° C.-8° C.), some types of food require an even colder temperature environment (typically temperatures lower than −15° C.), and other types of food require a higher temperature environment (typically temperatures above 10° C.).

WO2021209648 (Ocado Innovation Ltd) teaches a multi-temperature storage system comprising: a storage structure including a plurality of upright members, a plurality of horizontal members supported by the upright members and forming a grid pattern defining a plurality of grid cells and allowing containers to be arranged in stacks beneath the grid cells defined by the grid pattern, and a track system on top of the horizontal members. The track system is configured to allow a load-handling device to move across the storage structure to retrieve a container from a stack. The multi-temperature storage system further comprises a temperature-control means configured to maintain a first-temperature region within the storage structure at a first temperature and a second-temperature region within the storage structure (1) at a second temperature.

WO2021038437 (Attabotics Inc.) teaches a multi-zone automated storage and retrieval system (ASRS) comprising first and second storage zones isolated by at least one barrier and including first and second groups of storage locations respectively for accommodating storage units therein. The multi-zone ASRS includes one or more portals opening through the barrier(s) between the storage zones, and at least one track layout. The track layout(s) includes first and second track areas occupying the first and second storage zones respectively, and one or more connective track segments interconnecting the first and second track areas through the portal(s). The RSR Vs deposit and retrieve the storage units to and from the storage locations and travel on the first and second track areas via the connective track segment(s) to respectively access the first and second groups of storage locations therefrom.

For temperature sensitive goods or items in the storage containers such as frozen or chilled items, it is essential that the temperature of the goods or items are closely monitored or tracked. Without any form of temperature monitoring, there is a risk that the temperature of the items or goods in storage in one or more storage containers may be stored at temperatures exceeding the intended storage temperature as required by legislation. For example, chilled items or goods such as milk, cheese, etc. must be legally kept at 8° C. or below. Anything above this temperature will not only be in breach of the legal requirement for storage of chilled goods or items but in a worst case scenario, may result in spoiling of such goods or items. The problem of monitoring or tracking the temperature of the goods or items in storage is exacerbated when having a densely packed arrangement of stacks of storage containers as discussed above.

A system is thus required that will be able to monitor or track the temperature of temperature sensitive goods or items in storage in a storage and retrieval system.

### SUMMARY OF THE INVENTION

One option to monitor or track the temperature of temperature sensitive goods in storage is the provision of one or more temperature sensors distributed throughout a plurality of stacks of storage containers. For example, one or more wireless temperature sensors can be placed in one or more storage containers in one or more stacks of the storage containers that senses the temperature within a given storage container and wirelessly transmit a temperature signal to a remote base unit for processing the temperature signal. The base unit may comprise, for example, a personal digital assistant (PDA), a computer, or any other electronic device with suitable data processing capabilities and a communication link. The base unit can alternatively re-direct the signal to a control system via a communication link with suitable processing capabilities.

A plurality of wireless temperature sensors can be placed at regular intervals within a plurality of stacks of storage containers to provide an indication of the temperature distribution within the storage system. For example, a plurality of the wireless temperature sensors can be placed at different container depths, Z, in a single stack of storage containers. The storage containers in such storage systems are typically made of a thermoplastic material and may be formed by injection moulding or blow moulding, for example. Examples of thermoplastic materials include polypropylene, polyethylene (e.g. high density polyethylene (HDPE)), acrylonitrile butadiene styrene (ABS) and polycarbonate. The use of plastic material enables transmission of the wireless signal from the wireless temperature sensor through the walls of the storage containers with minimum attenuation or affecting the strength of the wireless signal. The signal from the plurality of wireless temperature sensors is of a sufficient strength when it reaches the base unit or the control system to enable the signal to be processed to provide an indication of temperature. However, a problem with using thermoplastic storage containers in the storage system described above is that thermoplastic storage containers can be highly flammable and emit toxic fumes. Given that the storage system may contain hundreds or thousands of storage containers, the storage containers can pose a significant risk in the event of a fire.

The problem is mitigated by fabricating the storage container from metal. In comparison to plastic material, the use of metal in the fabrication of the storage containers allows the storage containers to withstand much higher temperatures before disintegrating and emit very little or no toxic fumes in an event of a fire. In addition, more of the material of the storage containers is easily recyclable, making the storage containers of the present invention more environmentally friendly. WO2022229453 (Ocado Innovation Ltd) teaches a storage and retrieval system comprising a plurality of stacks of storage containers, each storage container of the plurality of stacks of storage containers comprising a metallic container body comprising a container bottom wall and upwardly standing opposing sidewalls and end walls to form a box-like structure with an open end for receiving the one or more items within the box-like structure. Each stack of the plurality of stacks of metallic storage containers is located below the track system and occupies a single grid space or grid cell. However, a problem with having a plurality of stacks of metal storage containers to store goods is the inability of the metal storage containers to transmit a wireless signal through a plurality of stacks of storage containers. The plurality of stacks of metal storage containers may act like a Faraday cage and shield or block the transmission of any wireless signal from one or more wireless temperature sensors stored in the metal storage containers removing the ability to monitor or track the temperature of the goods.

The present invention has mitigated the above problem by providing a wireless pathway amongst a plurality of stacks of metal storage container for the transmission of a wireless signal from at least one environmental sensor to a remote base unit outside of the grid framework structure. For the purpose of the present invention, the environmental sensor can be any sensor type used to measure temperature and/or humidity.

More specifically the present invention provides a storage and retrieval system, comprising:
a) a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling device on the grid framework structure, the plurality of the tracks being arranged such that each of the plurality of storage columns is below a single grid cell;
b) a plurality of stacks of storage containers, each storage container of the plurality of stacks of storage containers comprising a bottom wall and upwardly standing sidewalls and end walls; each stack of the plurality of stacks of storage containers occupying a single storage column of the plurality of storage columns, the plurality of stacks of storage containers comprising a plurality of a first type storage containers comprising a metallic container body and a plurality of a second type storage containers comprising a wireless transmittable container body;
c) an environmental monitoring system comprising:
   i) at least one environmental sensor comprising a wireless communication device for transmitting environmental data, the at least one environmental sensor being stored in at least one of the plurality of the second type storage containers to define a sensor container;
   ii) a base unit external of the grid framework structure, the base unit comprising a wireless communication device for receiving the environmental data from the communication device of the at least one environmental sensor;
      wherein the plurality of stacks of storage containers are arranged such that the sensor container is adjacent at least one of the other of the plurality of the second type of storage containers so providing a pathway outside of the grid framework structure for the transmission of the wireless signal from the at least one environmental sensor to the base unit.

For the purpose of definition, the ‘other’ of the plurality of the second type of storage containers are the second type of storage containers that do not contain the at least one environmental sensor, i.e. non-sensor container. Having the sensor container being adjacent to at least one of the other of the plurality of the other second type storage containers creates a pathway for a wireless signal to be transmitted from the at least one environmental sensor through the second type storage containers. In comparison to the first type storage container comprising a metal body, the second type storage container comprises a wireless transmittable container body that is able to transmit a wireless signal without or minimum loss of signal strength. Optionally, the wireless transmittable container body comprises a plastic material and/or one or more openings in the upwardly standing sidewalls and/or end walls and/or bottom wall of the plurality of the second type storage containers. The one or more openings in any one of the walls of the storage container enables transmission of the wireless signal through one or more of the storage containers.

There are numerous ways by which a pathway can be created amongst a plurality of stacks of metal storage containers for the transmission of a wireless signal from the at least one environmental sensor. Optionally, the plurality of stacks of storage containers are arranged such that the at least one of the upwardly standing sidewalls and/or end walls of the sensor container is adjacent at least one of the other of the plurality of the second type storage container. Optionally, the plurality of stacks of storage containers are arranged such that the bottom wall of the sensor container is adjacent at least one of the other of the plurality of the second type storage container. Optionally, the plurality of the second type storage containers are arranged in at least one vertical stack so as to create the pathway along the at least one vertical stack for the transmission of the wireless signal to the outside of the grid framework structure. Having at least one stack of the plurality of the second type storage containers provides a pathway amongst the plurality of the first type storage containers for the transmission of a wireless signal from the at least one environmental sensor to the base unit outside of the grid framework structure.

Optionally, the plurality of the first type storage containers are respectively arranged into a plurality of vertical stacks of the first type storage containers, the plurality of the vertical stacks of the first type storage containers being arranged around or surrounding the at least one stack of the plurality of the second type storage containers. Whilst having a plurality of stacks of the first type storage containers comprising a metal container body improves the fire resistance of the storage system, the present invention is still able to monitor or track the environmental condition of one or more storage containers buried deep within the grid framework structure by having at least one stack of the second type storage containers to create a pathway for transmission of a wireless signal from at least one environmental sensor to the base unit located outside of the grid framework structure.

In order to provide multiple pathways for the transmission of a wireless signal to the outside of the grid framework structure, optionally, the at least one vertical stack of the plurality of the second type storage containers comprises a plurality of stacks of the second type storage containers. Having multiple pathways for the transmission of a wireless signal is particularly important where the storage system comprises a large number of densely packed stacks of storage containers. Optionally, the plurality of stacks of the second type storage containers are distributed at regular intervals amongst the plurality of stacks of the first type storage containers such that each stack of the plurality of stacks of the second type storage containers comprises one or more neighbouring stacks of the first type storage containers.

However, having an arrangement of a relatively large number of densely packed stacks of the second type storage containers in comparison to the stacks of the first type storage containers in storage in the grid framework structure may have a detrimental effect on the fire safety of the storage and retrieval system. This is especially the case where the second type storage containers are formed from a plastic material. In contrast to having a large number of densely packed stacks of the second type storage containers, having a relatively large number of the first type storage containers may have a detrimental effect on the transmission of the wireless signal from the at least one environmental sensor to the base unit. As a compromise, a balance is needed between the level of fire safety of the grid framework structure and the transmission of the wireless signal from the at least one environmental sensor in one or more of the second type storage containers with sufficient strength to the base unit to enable the signal from the at least one environmental sensor to be processed. The present invention has realised that by arranging the stacks of the second type storage containers in a regular pattern amongst the stacks of the first type storage containers, the transmission of the wireless signal from the sensor container to the base station can be improved without jeopardising the fire safety of the storage and retrieval system. In one example of the storage and retrieval system, at least a portion of the plurality of stacks of storage containers comprises a regular pattern of discrete M by N stacks of the second type storage container separated by one or more stacks of the first type storage containers, wherein M and N is greater than or equal to one. In other words, the stacks of the second type storage containers are dispersed in a regular pattern within a matrix or an array of the first type storage containers forming discrete islands of one or more stacks of the second type storage containers. For the purpose of explanation, the discrete M by N stacks of the second type storage containers include neighbouring or adjacent stacks of M by N stacks of the second type storage containers dispersed within a matrix of the first type storage containers. At least one environmental sensor is stored in one or more of the storage containers in the stack of the M by N stacks of the second type storage containers so as to provide a pathway of a wireless signal to the outside of the grid framework structure.

There are various ways in which the stacks of the second type containers can be arranged within the matrix of the first type storage containers. Optionally, the value of M and N can be greater than or equal to 2. Optionally, M and N is equal to 2 such that the at least a portion of the plurality of stacks of storage containers are arranged in a regular pattern or an array of 2 by 2 stacks of the second type storage containers separated by one or more stacks of the first type storage containers. The 2 by 2 array of the second type storage containers surrounded by the first type storage containers provides optimal fire safety of the storage and retrieval system whilst allowing transmission of wireless signals through the 2 by 2 of stacks of the second type storage containers to the outside of the grid framework structure. For the case of a box-type second type storage container comprising a bottom wall and upwardly standing sidewalls, the term “surrounded” is construed to mean that the upwardly standing sidewalls of the second type storage container is adjacent or neighbours a metal storage container.

To provide an indication of the distribution of the environment (e.g. temperature and/or humidity) within one or more stacks of the storage containers, optionally, the at least one environmental sensor comprises a plurality of the environmental sensors, the plurality of the environmental sensors being stored in two or more storage containers of the plurality of the second type storage containers to define a plurality of sensor containers. Optionally, the plurality of the environmental sensors are distributed amongst the plurality of the second type of storage containers at regular intervals along the at least one vertical stack of the plurality of the second type storage containers. Distributing the plurality of the environmental sensors at regular intervals along the at least one vertical stack of the plurality of the second type storage containers provides an indication of the environment within the storage containers at the different container depths within a stack. Moreover, the at least one stack can be indicative of the sensing environment of neighbouring stacks of storage containers even if the neighbouring stacks of storage containers are of the first type storage containers.

Not all of the plurality of the second type of storage containers in a given stack need to comprise at least one environmental sensor in order to monitor or track the environmental condition at the different container depths. For example, the distribution of the plurality of environmental sensors along a given stack of the second type of storage containers can be such that the number of the sensor containers is less than the number of the other of the plurality of second type containers.

Optionally, the at least one environmental sensor comprises a temperature sensor and/or a humidity sensor. Thus, the at least one environmental sensor in the at least one second type storage container can monitor or track the temperature in the at least one second type storage container. This helps to monitor or track the status of temperature sensitive items or goods in storage to see whether they are being kept within a desired temperature range prior to being fulfilled to customer orders. Creating a pathway amongst the plurality of metal storage containers by the use of plastic containers for a wireless signal to be transmitted outside of the grid framework structure enables the base unit to receive signals from multiple temperature sensors distributed amongst a densely packed arrangement of stacks of storage containers. Moreover, having a plurality of the first type storage containers comprising a metal container body improves the fire resistance of the storage system.

In addition to measuring temperature, the at least one environmental sensor can comprise a humidity sensor. Humidity sensing data can be used in conjunction with temperature sensing data to calculate a dew point in any one of the plurality of storage containers in the storage system. This is particularly important where the storage containers are stored in a chilled temperatures or a freezer temperatures. Moving such storage containers from a cold environment to a warmer environment, e.g. ambient environment, may result in condensation on the storage containers and their contents. This is particularly the case when moving the first type storage containers comprising a metallic body to a warmer environment, e.g. an inventory handling station such as a pick station for retrieving one or more items from the storage container to fulfil customer orders. To mitigate condensation on such storage containers, it is important that the temperature of the storage container is less than the dew point temperature of the warmer environment. Various methods can be used in the warmer region to alter the dew point temperature such that it is less than the temperature of the storage container. For example, changing the moisture content of the air in the warmer region to a drier environment, i.e. lowering the moisture content, has the effect of reducing the dew point temperature. Conversely, the same is true when the warmer region is in the storage system. In this case, it is necessary to determine the dew point temperature in the storage system when moving storage containers and/or goods from a cold region for storage in the storage system. Calculated dew point temperature will determine the risk of condensation when a storage container is moved into storage in the storage system. As the second type storage containers provide a pathway for the transmission of a wireless signal outside of the grid framework structure, the dew point temperature of any particular storage container buried deep within the storage system can be provided, thereby providing an indication of condensation.

Optionally, the system further comprises an environmental control system, the environmental control system is configured to:
i) receive temperature and humidity sensing data from the temperature sensors and the humidity sensor;
ii) process the temperature and humidity sensing data to provide an indication of dew point.

Optionally, the system may comprise a plurality of robotic load handling devices for lifting and moving storage containers stacked in the storage columns, the plurality of load handling devices being remotely operated to move laterally on the track system above the plurality of storage columns to access the storage containers through the grid cells, each of said plurality of robotic load handling devices comprising:
a) a wheel assembly for guiding the load handling device on the track system;
b) a container-receiving space located above the track system; and
c) a lifting device arranged to lift a single container from a stack into the container-receiving space.

### BRIEF DESCRIPTION OF DRAWINGS

Further features and aspects of the present invention will be apparent from the following detailed description of an illustrative embodiment made with reference to the drawings, in which:

FIG. 1 is an illustration of a grid framework structure showing a storage area comprising a plurality of stacks of storage containers.

FIG. 2 is a schematic diagram of a top down view showing a stack of bins arranged within the framework structure of FIG. 1.

FIG. 3 is a schematic diagram of a storage and retrieval system showing a load handling device operating on the grid framework structure.

FIG. 4 is a schematic perspective view of the load handling device showing the container receiving space within the body of the load handling device.

FIG. 5A and FIG. 5B are schematic perspective cut away views of the load handling device of FIG. 4. FIG. 5A shows a container accommodating a container receiving space of the load handling device. FIG. 5B shows the container receiving space of the load handling device.

FIG. 6 is a perspective view of an automated storage and retrieval system according to an exemplary embodiment of the present invention.

FIG. 7 is a top plan view of the automated storage and retrieval system shown in FIG. 6.

FIG. 8 is a perspective view of a cross section of the grid framework structure showing the arrangement of the stack of the second type of storage containers amongst the first type of storage containers.

FIG. 9 is a perspective view of a cross section of the grid framework structure showing the stack of the second type of storage containers surrounded by a plurality of stacks of the first type storage containers.

FIG. 10 is a block diagram showing the control of the cooling system according to an embodiment of the present invention.

FIGS. 11A, 11B, and 11C are plan views of the grid framework structure showing an array of the plurality of stacks of storage containers. FIG. 11A shows a regular pattern of discrete 1×1 stack of the second type storage containers separated by the first type of storage containers. FIG. 11B shows a regular pattern of 2×2 stacks of the second type storage containers separated by the first type of storage containers. FIG. 11C shows a regular pattern of 7×10 stacks of the second type storage containers separated by the first type of storage containers.

### DETAILED DESCRIPTION

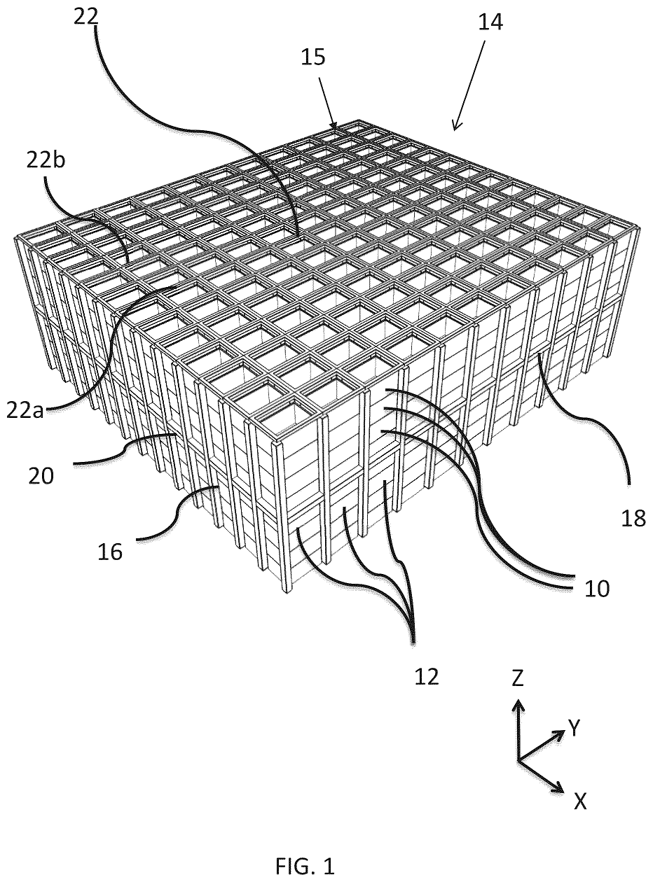

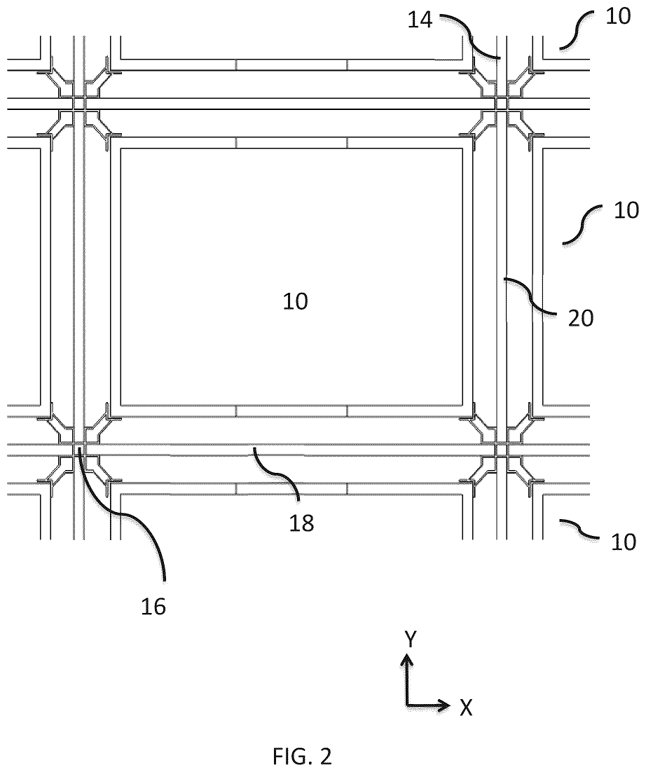

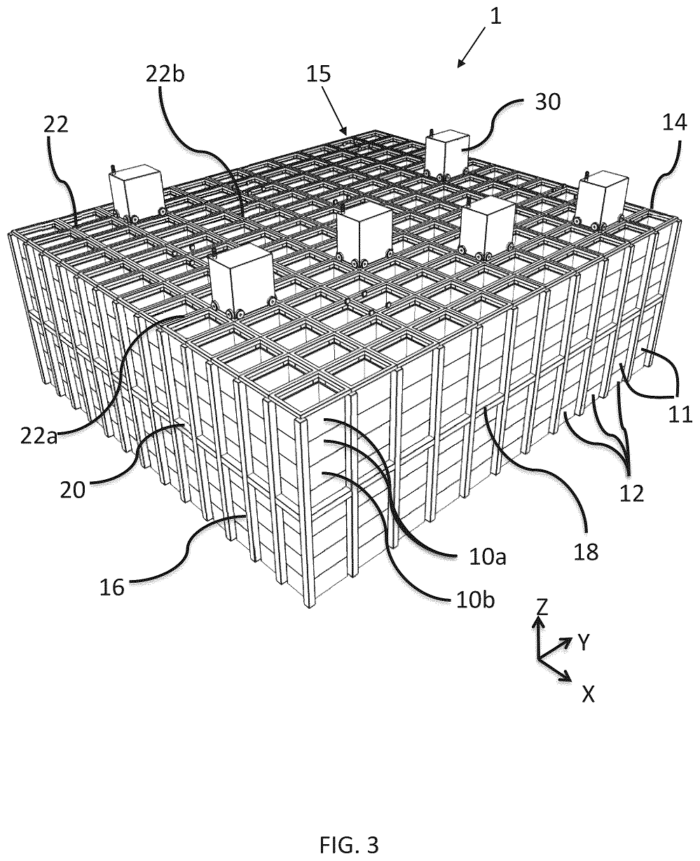

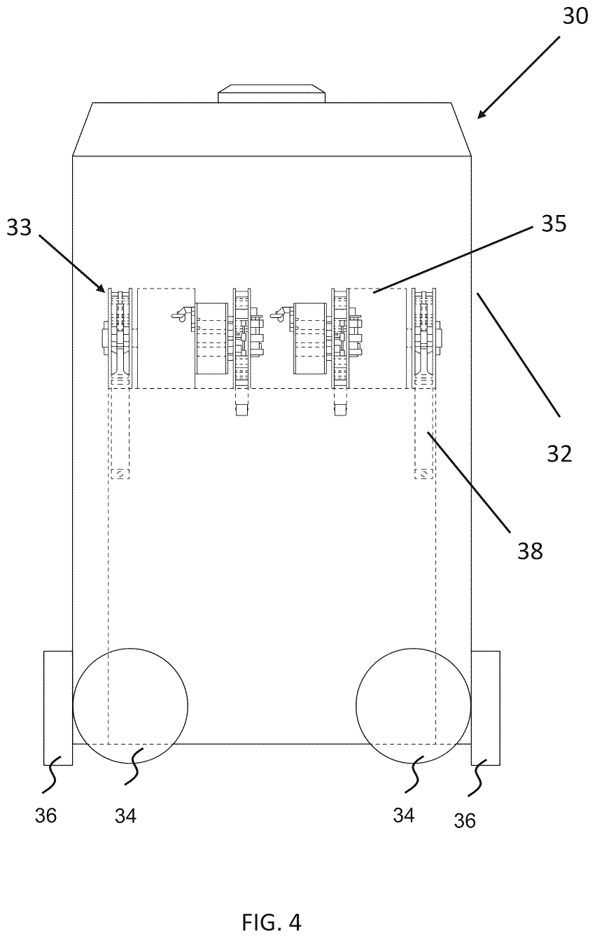

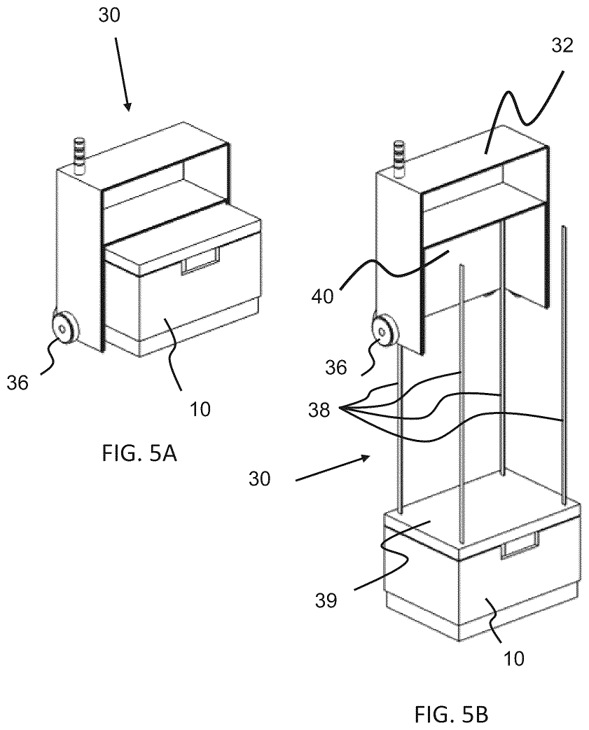

It is against the known features of the storage system such as the grid framework structure and the load handling device described above with reference to FIGS. 1 to 5A and 5B, the present invention has been devised. Typically, in any given time, there are a large number of robotic load handling devices operational on the track system.

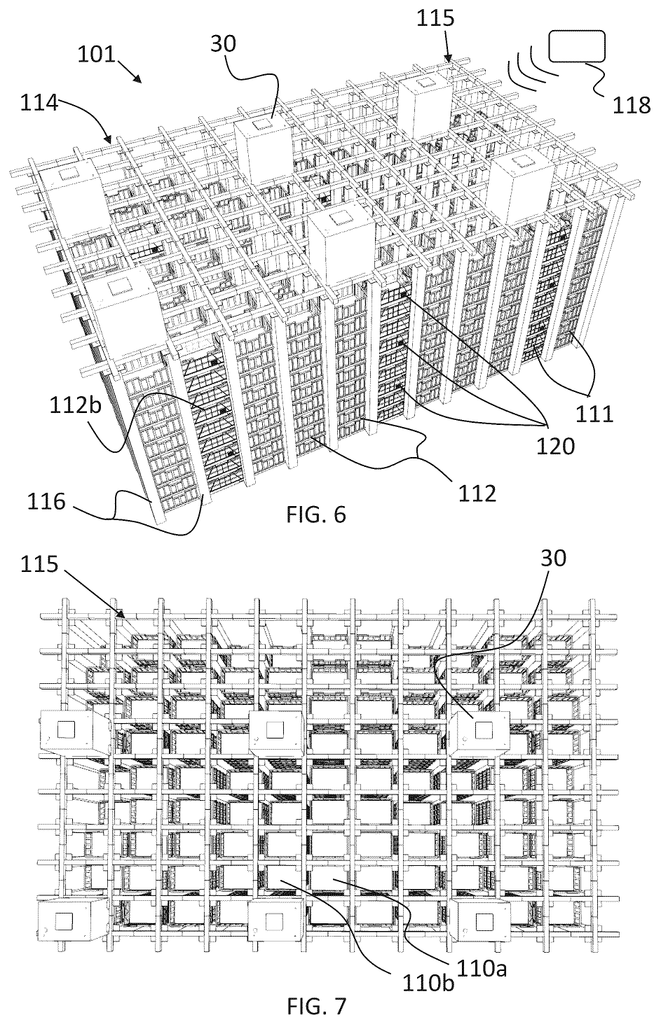

FIG. 6 shows a grid framework structure 114 comprising a plurality of storage columns 111 providing a storage area for the storage of a plurality of stacks of storage containers 112. Each of the plurality of storage columns 111 is sized to store a single stack 112 of storage containers 110a, 110b. The plurality of storage columns 111 can be defined by a plurality of vertical uprights 116 arranged to accommodate the four corners of the storage containers 110a, 110b. Alternatively, the plurality of storage columns can be defined by a plurality of tote guides arranged in a supporting framework structure comprising a plurality of prefabricated modular panels arranged in a grid pattern as taught in WO2022034195 (Ocado Innovation Ltd), the detail of which is incorporated herein by reference. In any case, the plurality of storage columns provides a storage area for the storage of the inventory in a densely packed arrangement. When used to store temperature sensitive goods or items, particularly those that comprise grocery items, at least a portion of the grid framework structure is partitioned to accommodate a cooling system such as a refrigerated unit to provide a either a chilled zone or a freezer zone.

Whilst various cooling systems known in the art are used to cool the storage area housing the plurality of stacks of storage containers, it is essential that the temperature of the items or goods in the storage containers are kept within their intended target temperature. For perishable goods, the legal requirement is for the goods to be kept at a temperature between 1° C. to 8° C. and for frozen goods, the goods should be ideally kept at a temperature at or below −18° C. For more temperature sensitive items such as fish, the temperature should ideally not exceed 5° C. The risk of spoiling one or more perishable food items in storage increases when the temperature falls outside these temperature ranges for an extended period of time. For the purpose of the present invention, the chilled zone or region operates in the target temperature range of 1° C. to 8° C. and the freezer zone or region operates in the temperature range of −30° C. to −18° C. Typically, the cooling system comprises one or more chillers or coolers or fans, etc., that control the temperature within the environment housing the plurality of stacks of storage containers. The chillers are, for example, evaporators or evaporative coolers configured with a wide range of cooling capacities to support cooling applications of the storage and retrieval system. These evaporative coolers cool air through the evaporation of water within the storage and retrieval system. The chillers or fans are normally located above the tracks and the system relies on cool air to flow through the walls of the storage containers. For example, cooling systems such as that described in UK Patent Application No GB1509661.3 (Ocado Innovation Limited), which is herein incorporated by reference, requires air to flow within the storage system and through the storage containers and stacks of storage containers and discloses a storage system comprising one or more chillers for generating temperature controlled gas, one or more fans for circulating the temperature controlled gas through the storage system; and a plenum for receiving the temperature controlled gas. Furthermore, should a portion of the storage system require cooling to a lower temperature, for example to enable storage of items requiring chilling, such as fruit and vegetables, it is more important that the air flow through the system cools the items to be stored. To enable, cool air to flow through the stacks of storage containers, the walls of the storage containers comprise one or more holes or apertures. The provision of holes or apertures in the storage container combined with the air flow through the storage system, enables the temperature of the items in the storage containers to be maintained at a uniform temperature across the storage system. Each of the storage containers allows air to flow through the storage containers when stacked in stacks within the grid framework structure. Furthermore, the holes, slots, or other forms of apertures in the storage containers are arranged so as to be aligned between bins when the stacks are arranged within the framework.

To monitor or track the temperature of the goods in the storage containers in the one or more stacks of the storage containers, one or more wireless temperature sensors 120 are distributed within the plurality of stacks of storage containers 110b, more specifically, one or more of the wireless temperature sensors are placed in storage in one or more storage containers. The wireless temperature sensors works on the principle of generating wireless signals comprising temperature data that are transmitted via a communication link to a remote base unit 118 within the storage and retrieval system to be processed to give an indication of temperature. The base unit 118 as shown in FIG. 6 is positioned outside of the grid framework structure. Signals indicative of the temperature from a plurality of the storage containers in the storage area are sent wirelessly to the base unit 118 via the communication link. The base unit 118 optionally comprises a processor for processing the signals from the wireless temperature sensor to provide an indication of the temperature inside the storage container or alternatively, the base unit can re-direct the wireless signal to a central control system comprising a processor for processing the signal.

The communication link can be any communication link over a wireless network known in the art. The network can be, for example, a local area network, a wide area network, a virtual private network, the Internet, an intranet, an extranet, a public switched telephone network, an infrared network, a wireless network and any combination thereof. Communications over the network use any of the communication protocols commonly known in the art and include but are not limited to Transmission Control Protocol/Internet Protocol (“TCP/IP”), Open System Interconnection (“OSI”), File Transfer Protocol (“FTP”), Universal Plug and Play (UpnP”), Network File System (“NFS”), Common Internet File System (“CFIS”) and AppleTalk. The wireless signal can any of electromagnetic waves (radio waves, microwaves, infrared, light, laser, Lidar, terahertz radiation), sound, or any transmission medium that may be utilized for wireless communications.

Whilst storage containers towards the outside of the grid framework structure benefit from the cooling effects of the cooling system because they are nearest to the cooling system, storage containers buried deep within the grid framework structure may not benefit from the full effect of the cooling system as they may be shielded by other storage containers from the surrounding stacks of storage containers 112. As a result, the temperature of one or more storage containers buried within the plurality of stacks of storage containers and their contents may fall outside the required target storage temperature. For the purpose of definition, the storage containers buried deep amongst a plurality of stacks of storage containers are termed “deep buried storage containers”. To identify those deep buried storage containers that may not reach the required target storage temperature, one or more wireless temperature sensors are placed in the storage containers to monitor or track the temperature of the contents of the storage containers. For the purpose of definition and to differentiate storage containers comprising the wireless temperature sensors from the other storage containers in the storage system that do not contain the wireless temperature sensors, the storage containers comprising the wireless temperature sensors are defined as sensor containers 122. The wireless temperature sensors 120 are strategically placed in the storage containers so as to provide an indication of the temperature of the storage containers at different layers of the stack from the bottom layer to the uppermost top layer. Taking Z as the container depth and Z=1 as the uppermost layer of the grid, i.e. the layer immediately below the rail system, Z=2 is the second layer below the rail system and so on to the lowermost, bottom layer of the grid, then the wireless temperature sensors are placed at different containers depths Z to provide an indication of the temperature of the storage containers at the different levels, Z, of the stack.

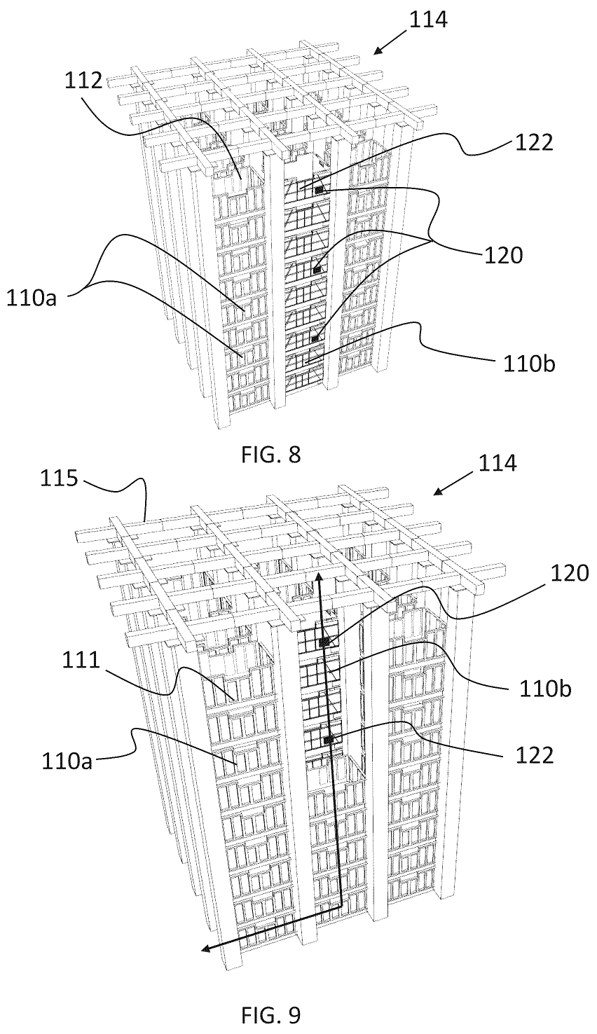

In the particular embodiment of the present invention, a plurality of the wireless temperature sensors 120 can be distributed within the plurality of stacks of storage containers 110b to provide an indication of the temperature distribution within a stack of storage containers 112. The simplest approach would be to identify a stack of storage containers in the storage area that will be representative of the temperature distribution within a given region of the plurality of stacks of storage containers and to separately place wireless temperature sensors 120 in one or more of the plurality of the storage containers 110b in the stack 112. In the particular embodiment of the present invention shown in FIG. 6 and FIG. 8, a plurality of the wireless temperature sensors 120 are placed at regular intervals in one or more storage containers 110b in a given stack of storage containers 112 such that storage containers comprising wireless temperature sensors (i.e. defined herein as “sensor containers”) are separated by one or more storage containers without a wireless temperature sensor in the stack. For example, in a given stack of nine storage containers shown in FIG. 8, three of the storage containers 110b comprise a wireless temperature sensor 120 to define sensor containers 122 at regular intervals along the height of the stack of storage containers. The lowermost sensor container 120 shown in FIG. 6 at level Z=3 provides a temperature reading, T₁ in the stack, the middle sensor container at level Z=6 provides a temperature reading, T₂, and the uppermost sensor container at level Z=9 provides a temperature reading, T₃. However, the present invention is not limited to spacing apart the sensor containers in the storage area by one or more storage containers. For example, in a given stack of storage containers, every storage container can be sensor container. For a chilled environmental, in a given stack of storage containers, the temperature inside the storage containers should be kept within the legal limit of 1° C. to 8° C. Where the temperature of any storage container in a given stack of storage containers falls outside this temperature limit for an extended period of time, the storage containers are removed from storage and their contents are disposed.

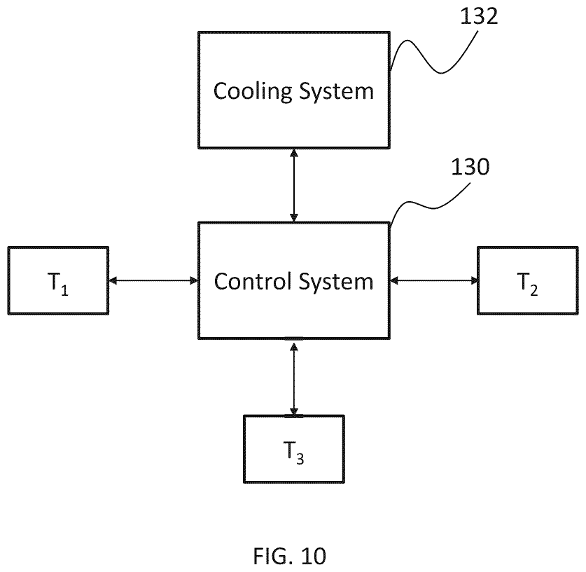

To mitigate spoiling of the goods, particularly perishable food items, a control system 130 in response to the temperature readings from the wireless temperature sensors 120 control the cooling system 132 so as to control the temperature environment within the storage system 101. As shown in the block diagram shown in FIG. 10, a feedback loop exists between the control system 130 and the wireless temperature sensors to continuously monitor the temperature of the storage containers (i.e. sensor containers). If any of the temperature readings fall outside the required temperature limit, the control system 130 adjusts the cooling system such that the temperature readings, T₁, T₂, T₃ from the wireless temperature sensors 130 fall within the required temperature limit. Alternatively, the control system can instruct one or more robotic load handling devices operable on the track system 115 to rearrange one or more storage containers such that they are more exposed to the cooling system.

Not only are the wireless temperature sensors 120 distributed at regular intervals within a given stack of storage containers but a plurality of stacks of storage containers 112 comprising the wireless temperature sensors 120 can also be distributed at regular intervals amongst a plurality of stacks of storage containers 112 such that the plurality of storage containers comprising the wireless temperature sensors 120 neighbours one or more stacks of storage containers without the wireless temperature sensors as shown in FIG. 6. The control system is able to generate a heat map showing the temperature distribution within the storage system so as to identify areas of the storage area that need further attention. For example, warmer areas of the storage system falling outside the required temperature range can be identified, particularly, those storage containers buried deep within the storage system. Remedial action can be taken to either remove the contents of such storage containers or they can be re-positioned so that they are more exposed to the cooling effects of the cooling system.

The ability of the base unit 118 or the control system 130 to process the wireless signal from the wireless temperature sensors to provide an indication of temperature is dependent on the strength and/or quality of the signal reaching the base unit, which in turn is dependent on the level of attenuation of the signal before it is received by the base unit. Storage containers largely composed of plastic material offer very little resistance to the signals from the wireless temperature sensors with little loss in signal strength when passing through the walls of the storage container. Examples of plastic materials include various thermoplastic material including but is not limited to polypropylene, polyethylene (e.g. high density polyethylene (HDPE)), acrylonitrile butadiene styrene (ABS) and polycarbonate. A problem with using thermoplastic storage containers in the storage system described above is that they can be highly flammable and emit toxic fumes, and given that the storage system may contain hundreds or thousands of storage containers, the storage containers pose a significant risk in the event of a fire.

The problem can be mitigated by fabricating the storage containers from metal. In comparison to plastic material, the use of metal in the fabrication of the storage containers allows the storage containers to withstand much higher temperatures before disintegrating and emit very little or no toxic fumes in an event of a fire. However, in comparison to plastic material, metal has a tendency to attenuate the wireless signal resulting in partial or complete loss of the signal. Moreover, a plurality of stacks of metal storage containers creates an enclosure that blocks transmission of the wireless signal from one or more wireless temperature sensors in storage removing the ability of generating a heat map of the storage area, i.e. the plurality of stacks of storage containers behave as a Faraday shield. As a result, there is a conflict between improving the fire resistance of the storage system and providing an environmental monitoring system for monitoring or tracking the temperature of the contents of the storage containers in the storage area.

In one aspect of the present invention, a pathway is provided amongst a plurality of stacks of metal storage containers for the transmission of a wireless signal from one or more wireless temperature sensors in the storage area to the base unit 118. As the base unit 118 is located outside of the grid framework structure, ideally the pathway should extend to the outside of the grid framework structure for the signal to reach the base unit. In one example of the pathway, a plurality of plastic storage containers 110b can be stored amongst a plurality of metal containers 110a so as to provide a pathway for the transmission of a wireless signal to the outside of the grid framework structure. Whilst the pathways amongst the plurality of metal storage containers 110a is provided by plastic storage containers 110b, the transmission of a wireless signal through a plurality of storage containers is not limited to plastic storage containers. For example, the bottom wall and/or upwardly standing sidewalls and/or end walls of the storage container can comprise holes or openings for the transmission of the wireless signal. Thus, for the purpose of definition, the plurality of storage containers comprises a plurality of a first type storage container and a second type storage container. To improve the fire resistance of the storage area, the first type storage container comprises a metal body. Since transmission of the wireless signal is not limited to being plastic, the second type storage container is not limited to being plastic and comprises a wireless transmittable container body. However, for storage of food items, it is necessary that the lower portion of the storage container is leak proof to prevent juices from one or more food items contaminating one or more items stored in adjacent storage containers in a stack. As plastic storage containers are leaf proof and the walls of the storage container are transparent to wireless signals, the particular example of the present invention will be described with reference to the second type storage containers comprising a plastic container body (defined herein as plastic storage container or plastic container). Equally, the first type storage container comprising a metal container body is defined herein as a metal storage container or metal container.

The wireless temperature sensor 120 can be stored in at least one of the plastic storage containers and the other of the plastic containers can be arranged amongst the plurality of metal storage containers so as to create a pathway for the transmission of the wireless signal to the outside of the grid framework structure. For ease of explanation of the present invention, the metal storage containers can be denoted by the reference numeral 110a and the plastic storage containers can be denoted by the reference numeral 110b in FIGS. 6 to 9. There are numerous ways by which the plurality of plastic storage containers 110b can be arranged amongst the plurality of stacks of metal containers 110a to provide a pathway for the transmission of a wireless signal to the base unit 118. In one example of the present invention, a plurality of the plastic storage containers 110b are arranged in at least one stack 112 providing a pathway for the transmission of the wireless signal to the outside of the grid framework structure. One or more of the plastic storage containers 110b in the stack comprises at least one wireless temperature sensor 120 such that the signal generated by the sensor 120 is transmitted along the stack to be processed by the base unit or separate control system outside of the grid framework structure. Considering that a storage container comprises a bottom wall and upwardly standing sidewalls and end walls, the pathway of the wireless signal is through the bottom wall of adjacent plastic storage containers along the stack. This is shown by the arrow along a stack of plastic storage containers 110b buried amongst neighbouring stacks of metal storage containers 110a shown in FIG. 9. However, the present invention is not limited to arranging the plurality of plastic storage containers in a stack in order to provide a pathway for the transmission of a wireless signal to the outside of the grid framework structure. For example, the plurality of plastic storage containers 110b can be arranged side-by-side as shown by the arrow in FIG. 9 such that the wireless signal travels through the upwardly standing sidewalls and/or end walls of adjacent storage containers 110b. This creates a pathway along a row or level of the plurality of stacks of storage containers for the transmission of a wireless signal from the wireless temperature sensor in at least one of the plastic storage containers to the outside of the gird framework structure. In both cases, at least one sensor container 122 buried deep within the plurality of stacks of storage containers is always adjacent a plastic storage container 110b to create a pathway for the transmission of a wireless signal along neighbouring storage containers.

To generate a heat map showing the temperature distribution amongst a plurality of stacks of storage containers in the storage system, the storage system comprises a plurality of wireless pathways provided by a plurality of stacks of plastic storage containers 110b distributed amongst the plurality of metal storage containers 110a as shown in FIG. 6. The plurality of stacks of plastic storage containers being arranged at regular intervals amongst the plurality of metal storage containers so as to not greatly affect the fire resistance of the storage system comprising the plurality of storage containers. To prevent the spread of fire to neighbouring stacks of plastic storage containers, the plurality of stacks of plastic storage containers are arranged such that each stack of the plurality of stacks of plastic containers 110b neighbours one or more stacks of metal storage containers 110a. In the particular embodiment of the present invention shown in FIGS. 6, 7, 8 and 9, each stack of the plurality of plastic containers 110b are surrounded by a plurality of stack of metal containers 110a to provide a fire wall to prevent or mitigate the spread of fire amongst a plurality of stacks of plastic storage containers in the storage area. In terms of a box-type plastic storage containers, the term “surround” is broadly construed to mean that the upwardly standing sidewalls of the plastic storage containers is adjacent or neighbours one or more metal storage containers.

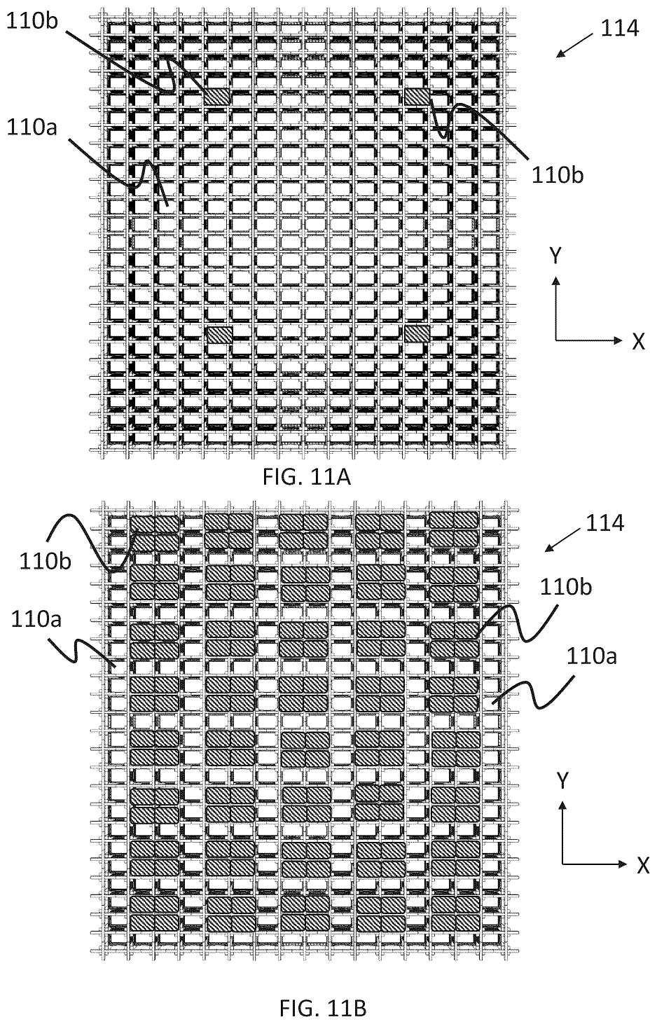

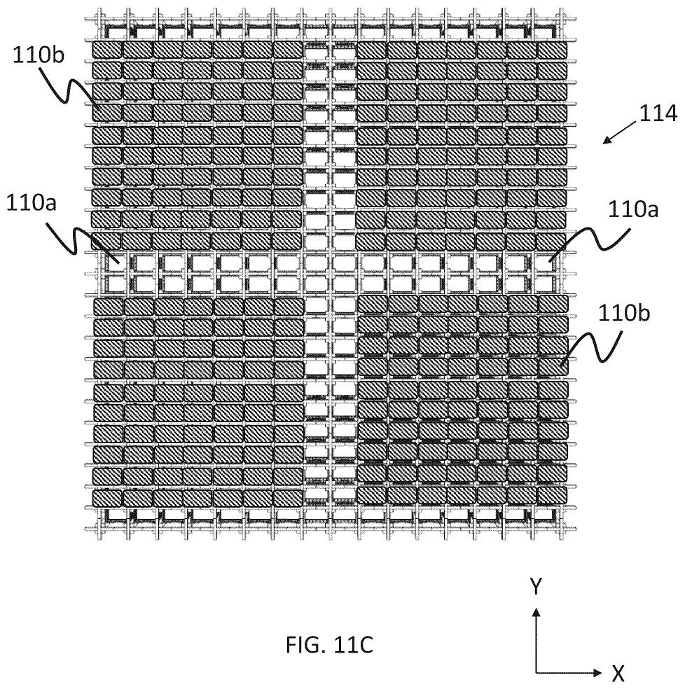

Different numbers of stacks of the plastic storage containers (second type) 110b can be incorporated within a matrix of stacks of the metal storage containers (first type) 110a to prevent the spread of fire to neighbouring stacks of the plastic containers 110b. The separation of one or more stacks of the plastic storage containers 110b by the stacks of the metal storage containers 110a provides a firewall to prevent the spread of fire from the one or more stacks of the plastic storage containers to a neighbouring stack of plastic storage containers. FIGS. 11A, 11B, and 11C show different examples of an array of the plurality of stacks of the metal and plastic storage containers in storage in the grid framework structure 114. At one extreme shown in FIG. 11A, the array of the stacks of plastic and metal storage containers can be arranged such that there is a plurality of single stacks of the plastic storage containers 110b within a matrix of the stacks of the metal storage containers 110a such that each single stack of the plastic storage containers 110b is surrounded by stacks of metal storage containers 110a. One or more of the single stacks of the plastic storage containers 110b can comprise the sensor container for transmission and/or reception of wireless signals to and from the base unit 118 outside of the grid framework structure. In the particular example shown in FIG. 11A, the single stack of the plastic containers 110b is arranged in a repeating pattern separated in the horizontal plane by seven stacks of the metal storage containers in the first direction (X-direction) and twelve stacks of the metal storage container in the second direction (Y direction), i.e., a regular pattern of 8 by 13 stacks of the storage containers. The separation of single stacks of the plastic containers by multiple stacks of the metal storage containers provides improved fire safety to prevent the spread of fire to a neighbouring stack of the plastic containers. As a result, less aggressive fire suppression systems are needed such as the number of sprinklers or fire extinguishing equipment to extinguish any fire with one or more of the plastic storage containers. This is because the first will be contained with a single stack of the plastic containers.

However, the use of plastic material in the fabrication of storage containers has advantages over the use of metal. These include to having a high strength-to-weight ratio, stiffness and toughness, ductility, corrosion resistance, bio-inertness, high thermal/electrical insulation, non-toxicity and outstanding durability at a relatively low lifetime cost. In comparison to plastic, metal has a tendency to corrode more easily than plastic and more susceptible to be taken out of shape due to bending, i.e., less resilient. As a result, like for like storage containers in terms of shape and weight, the metal storage container tends to be more expensive than their plastic counterparts. Reducing the cost of metal storage containers by the use of lower cost metal such as galvanised steel may suffer from the problem of food safety if the food comes into direct contact with the metal. However, the main drawback of plastic in comparison to metal is the ease by which plastic can spread fire in a storage and retrieval system.

To attain the benefits of the plastic storage containers whilst retaining the fire safety aspect of the metal storage containers, the plurality of the storage containers can be arranged such that there is a greater proportion of the plastic storage containers 110b amongst the stacks of the metal storage containers 110a. In the particular example shown in FIG. 11B, the plurality of the storage containers is arranged such that there is a repeating pattern of discrete 2 by 2 stacks of the plastic containers 110b within a matrix of the stacks of metal storage containers 110a. This results in the plastic storage containers occupying 45% of the plurality of the storage containers and the metal storage containers occupying 55% of the plurality of the storage containers. In the example shown in FIG. 11B, each of the discrete 2 by 2 stacks of the plastic storage containers are separated by one stack of the metal storage container in the X and Y directions, i.e., a single wall of the metal storage containers separates adjacent or neighbouring 2 by 2 stacks of the plastic storage containers in the X and Y directions. Thus, any fire of the plastic storage containers is contained within the discrete stacks of 2 by 2 plastic storage containers by the surrounding stacks of the metal storage containers. This is considered the optimal arrangement of the plastic and metal storage containers in the grid framework structure. However, the separation of the 2 by 2 stacks of plastic storage containers is not limited to a single wall of the metal storage containers and can by one or more stacks of the metal storage containers in the X and Y directions. In all cases, any fire generated in one or more plastic storage containers is contained within an area of the 2 by 2 stacks of plastic storage containers, i.e., the stacks of metal containers surrounding the plastic containers act as a heat shield.

At the other extreme of fire safety shown in the arrangement of the storage containers in FIG. 11C, the plastic storage containers occupy a greater proportion of the plurality of storage containers and therefore, possess the advantages of the plastic storage containers such as cost and resilience discussed above. In the particular example shown in FIG. 11C, the plastic storage containers are arranged such that the stacks of the plastic storage containers are arranged in discrete 7 by 10 blocks or groups of stacks of the plastic storage containers 110b separated by 2 stacks of the metal storage containers in the X and Y directions forming a fire wall between the blocks of plastic storage containers, i.e., the plastic storage containers occupy 65% of the plurality of storage containers. Whilst the arrangement of the plastic storage containers shown in FIG. 11C benefits from the lower cost of the plastic storage containers, the fire is contained within a larger group of plastic storage containers. As a result, more extensive fire extinguishing systems such as sprinklers would be required to extinguish a fire within a block of plastic storage containers. Various different arrangements of the stacks of the plastic containers separated by one or more stacks of metal storage containers between the two extremes shown in FIG. 11A and FIG. 11C are permissible in the present invention. The arrangement of the stacks of plastic storage containers separated by the stacks of the metal storage containers can be expressed as a pattern of discrete M by N stacks of plastic storage containers separated by one or more stacks of the metal storage containers; where M and N is greater than or equal to one. For example, FIG. 11A shows the pattern of the plurality of stacks of plastic and metal storage containers where M and N is equal to one; FIG. 11B shows the pattern of the stacks of plastic and metal plurality of storage containers where M and N is equal to two and FIG. 11C shows the pattern of the stacks of plastic and metal storage containers where M is equal to 7 and N is equal to 10. A greater number of stacks of plastic storage containers provides a lower cost storage and retrieval system, albeit with increased risk of fire and the need for extensive fire extinguishing equipment. Conversely, the greater the number of metal storage containers, the higher the cost of the storage and retrieval system, albeit with increased fire safety and the reduced need for extensive fire extinguishing equipment.

In all of the examples discussed above with reference to FIGS. 11A, 11B, and 11C, the pattern of the stacks of plastic storage containers within a matrix of the stacks of metal storage containers is applied to at least a portion of the plurality of storage containers. Depending on the position of the grid framework structure, one or more plastic storage containers may be exposed at the edge or corner of the plurality of stacks of storage containers, in which case they are not surrounded on all four sides by stacks of metal totes but rather on at least two sides. In this case, any exposed sidewalls of the plastic storage containers are easily accessible by any fire extinguishing equipment and thereby, have little tendency to spread to other stacks of plastic containers that are separated by one or more stacks of metal storage containers within the storage system.

Whilst the sensor type in the particular example discussed above is a temperature sensor, the present invention is not limited to the sensor type being a temperature sensor and can be any type of sensor. For the purpose of definition, the sensor can be broadly termed an environmental sensor. In addition to a temperature sensor, examples of environmental sensors include but are not limited to a humidity sensor. Data from the temperature and humidity sensors can be used to provide an indication of the dew point temperature of the storage environment. This is particularly important where the storage system is used to store temperature sensitive goods, e.g. chilled or frozen temperature. Moving storage containers from a cold environment to a warmer environment risks condensation of the moisture in the air on the storage containers and/or any contents of the storage containers if the temperature of the storage containers is below the dew point temperature of the warmer environment. This is particularly the case when moving metal storage containers from a cold region to a warmer region. Having an understanding of a heat map showing the temperature distribution across the plurality of stacks of storage containers enables the dew point temperature in the warmer region to be controlled so as to be below the temperature of the storage containers to prevent condensation. Movement of the storage containers to the warmer region may be required to gain access to the contents of the storage containers, e.g. for picking to fulfil customer orders. By measuring the environmental condition in the storage containers, the environment in the warmer region can be tailored to mitigate condensation. For example, the moisture content in the warmer region can be controlled by tailoring the humidity, e.g. via a dehumidifier, so as to mitigate condensation on the storage containers when taken out of the storage area. Controlling the moisture content in the warmer region can based on the temperature measurement of the storage container being higher than the dew point temperature of the environment in the warmer region.

Conversely, where the warmer region is the storage area comprising the plurality of stacks of storage containers, having a heat map showing the distribution of the dew point temperature in the storage area permits the moisture content in the storage area to be tailored to prevent condensation on the storage containers when moving one or more storage containers into the storage area from a cold environment. For example, when decanting goods from a distribution system into the storage containers, the goods may be kept at a lower temperature than the temperature of the storage area in the grid framework structure. The control system can control one or more dehumidifiers in the storage system to ensure that the dew point temperature measured by the wireless environmental sensors is below the temperature of the goods entering the storage system. As with temperature sensors shown in FIG. 10, the control system can control one or more dehumidifiers in the storage area via a feedback loop to control the dew point temperature in the storage containers.

In another alternative embodiment of the present invention, one or more stacks of the metal storage containers can function as an antenna for transmitting a signal to the base station outside of the grid framework structure. Thus, instead of using a stack of the plastic storage containers to provide a path for transmitting the wireless signal through the walls of the plastic storage containers from the environmental sensor, the one or more stacks of the metal containers can extend the range of the signal by functioning as an antenna or aerial. The environmental sensor comprises a transmitter and/or receiver configured to transmit and/or receive signals from the base station outside of the grid framework structure. The transmitter of the environmental sensor can be attached to at least one sidewall of a given metal storage container in a stack of the metal storage containers so as to extend the range of the signal along the stack of the metal storage containers. As the metal storage containers are in physical contact with each other in a stack, any signal transmitted by the transmitter is transmitted along the stack of the metal storage containers, thereby extending the range of the transmitter, i.e., the stack of the metal storage containers functions as an antenna. Using a stack of the metal storages as an antenna removes the need to have a separate stack of plastic storage containers to provide a path for the wireless signal. This further increases the fire safety aspect of the storage and retrieval system.

1. A storage and retrieval system, comprising:
a) a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling device on the grid framework structure, the plurality of the tracks being arranged such that each of the plurality of storage columns is below a single grid cell;
b) a plurality of stacks of storage containers, each storage container of the plurality of stacks of storage containers comprising a bottom wall and upwardly standing sidewalls and end walls;
each stack of the plurality of stacks of storage containers occupying a single storage column of the plurality of storage columns, the plurality of stacks of storage containers comprising a plurality of a first type storage containers comprising a metallic container body and a plurality of a second type storage containers comprising a wireless transmittable container body; and
c) an environmental monitoring system comprising:
i) at least one environmental sensor comprising a wireless communication device for transmitting environmental data, the at least one environmental sensor being stored in at least one of the plurality of the second type storage containers to define a sensor container;
ii) a base unit external of the grid framework structure, the base unit comprising a wireless communication device for receiving the environmental data from the communication device of the at least one environmental sensor;
wherein the plurality of stacks of storage containers are arranged such that the sensor container is adjacent at least one of the other of the plurality of the second type storage containers so providing a pathway to the outside of the grid framework structure for the transmission of the wireless signal from the at least one environmental sensor to the base unit.

2. The system of claim 1, wherein the wireless transmittable container body comprises plastic material and/or one or more openings in the upwardly standing sidewalls and/or end walls and/or bottom wall of the second type storage container.

3. The system of claim 1, wherein the plurality of stacks of storage containers are arranged such that the at least one of the upwardly standing sidewalls and/or end walls of the sensor container is adjacent at least one of the other of the plurality of the second type storage container.

4. The system of claim 2, wherein the plurality of stacks of storage containers are arranged such that the bottom wall of the sensor container is adjacent at least one of the other of the plurality of the second type storage container.

5. The system of claim 4, wherein the plurality of the second type storage containers are arranged in at least one vertical stack so as to create the pathway along the at least one vertical stack for the transmission of the wireless signal to the outside of the grid framework structure.

6. The system of claim 5, wherein the plurality of the first type storage containers are respectively arranged into a plurality of vertical stacks of the first type storage containers, the plurality of the vertical stacks of the first type storage containers being arranged around the at least one stack of the plurality of the second type storage containers.

7. The system of claim 6, wherein the at least one vertical stack of the plurality of the second type storage containers comprises a plurality of stacks of the second type storage containers.

8. The system of claim 7, wherein the plurality of stacks of the second type storage containers are distributed at regular intervals amongst the plurality of vertical stacks of the first type storage containers such that each stack of the plurality of stacks of the second type storage containers comprises one or more neighbouring stacks of the first type storage containers.

9. The system of claim 1, wherein at least a portion of the plurality of stacks of storage containers comprises a regular pattern of discrete M by N stacks of the second type storage containers separated by one or more stacks of the first type storage containers, wherein M and N are greater than or equal to one.

10. The system of claim 9, wherein M and N are equal to or greater than 2.

11. The system of claim 10, wherein M and N are equal to 2 such that the at least a portion of the plurality of stacks of storage containers are arranged in a regular pattern of discrete 2 by 2 stacks of the second type storage container separated by one or more stacks of the first type storage containers.

12. The system of claim 1, wherein the at least one environmental sensor comprises a plurality of the environmental sensors stored in two or more storage containers of the plurality of the second type storage containers to define a plurality of sensor containers.

13. The system of claim 12, wherein the plurality of the environmental sensors are distributed amongst the plurality of the second type of storage containers at regular intervals along the at least one vertical stack of the plurality of the second type storage containers.

14. The system of claim 13, wherein in the at least one vertical stack of the plurality of second type containers, the number of the sensor containers is less than the number of the other of the plurality of second type storage containers.

15. The system of claim 1, wherein the at least one environmental sensor comprises a temperature sensor and/or a humidity sensor.

16. The system of claim 15, further comprising an environmental control system, the environmental control system is configured to:
i) receive temperature and humidity sensing data from the temperature sensors and the humidity sensor; and
ii) process the temperature and humidity sensing data to provide an indication of dew point.

17. The system of claim 1, comprising a plurality of robotic load handling devices for lifting and moving storage containers stacked in the storage columns, the plurality of load handling devices being remotely operated to move laterally on the track system above the plurality of storage columns to access the storage containers through the grid cells, each of said plurality of robotic load handling devices comprising:
a) a wheel assembly for guiding the load handling device on the track system;
b) a container-receiving space located above the track system; and
c) a lifting device arranged to lift a single container from a stack into the container-receiving space.
